(19) United States
(12) Patent Application Publication
(10) Pub. No.: US 2006/0190316 A1
(43) Pub. Date: Aug. 24, 2006

(54) Computer based system and method for gathering and processing scientific project data

(76) Inventors: John Alexander Dankowych, Toronto (CA); William Russell Gilmour, Thornhill (CA)

Correspondence Address: FETHERSTONHAUGH - SMART & BIGGAR, 1000 DE LA GAUCHETIERE WEST, SUITE 3300, MONTREAL, QC, H3B 4W5, CA

(21) Appl. No.: 11/289,704

(22) Filed: Nov. 30, 2005

(30) Foreign Application Priority Data
Dec. 31, 2004 (CA) 2,491,381

(51) Int. Cl. G06F 15/02

(52) U.S. Cl. 705/9

(57) ABSTRACT

An apparatus and method for automating credit-eligibility determination (such as tax credits) of scientific or research projects are provided. The apparatus includes a general purpose computing device that is operable to determine a set of weightings to be applied to responses that are received for a predefined set of questions. The determination is made, in part, by having the apparatus compare the responses to a project already known to be eligible for scientific or research credits. Once the weightings are determined, a final questionnaire is generated that has the weightings associated with corresponding questions. The final questionnaire can be used to assess credit-eligibility of future scientific or research projects.

### FIELD OF THE INVENTION

The present invention relates generally to scientific projects and more particularly relates to a system and method for gathering and processing data relating to scientific projects.

### BACKGROUND OF THE INVENTION

Scientific projects often include research, development and experimentation. Large projects are undertaken at considerable risk and expense and involve considerable complexity to implement. It is known for governments to provide incentives to entities that conduct such scientific projects to help offset some of this risk and encourage innovation through scientific projects. These incentives can take the form of tax credits or other tax benefits. For example, in Canada, entities are entitled to tax credits under the Scientific Research and Experimental Development Program (“SR&ED”). Details about the SR&ED are available at the Canada Revenue Agency's website, at http://www.cra-arc.gc.ca. Other jurisdictions also have programs similar to the SR&ED.

In order to claim tax credits under SR&ED, the applicant needs to undertake considerable effort to gather information about a particular project and compile it in a proscribed and meaningful format to the relevant tax authority. Currently, such effort is undertaken manually, and therefore can be slow, cumbersome, prone to error and a certain degree of subjectivity. Even once such material is compiled, it still must be reviewed by the relevant tax authorities to assess the eligibility of the claim.

The prior art has made certain attempts to overcome various limitations by automating at least part of the compilation. US2002/016797 discloses method and apparatus for creating an online questionnaire, accessible at a secure network site. The questionnaire is for collecting data used in the documenting and calculating R&D tax credit. Tools are provided to assist administrative functions such as setting up the due dates of an interview campaign, sending email notices and creating tracking and analysis reports regarding the questionnaire. Interviewees may access online help in the form of instructions, definitions, samples and incentives for timely completion of the questionnaire. US2003/0101114 also discloses method for calculating tax credit information that includes providing an on-line reporting form to a plurality of users. Information regarding allocation of financial resources regarding one or more projects associated with more than one of the plurality of users is collected from the users. Tax credit information is calculated based upon the allocation of financial resources regarding the one or more projects. At least some of the information collected from the more than one of the plurality of users is automatically verified while the information is being input by the more than one of the plurality of users. The automatic verification includes comparing information with stored data within one or more database. While these two references do provide a degree of automation, they include questionnaires that themselves may not be appropriately weighted, and more significantly, the electronic questionnaires include several fields that are left open for the applicant to enter free form information (See FIG. 5B of US2002/0016797 and FIG. 7A of US2003/0101114)—thus limiting the extent to which the assessment of the information can be analyzed and still depending on a large degree of manual analysis. Thus, such tools are best viewed as automating the collection of information, with reduced ability to conduct any detailed analysis. As a general problem with the prior art attempts to automate collection of data for scientific projects, it is not known whether the automated questions are likely to elicit answers that are consistent with manual techniques for assessing eligibility. Further, since such prior art attempts simply automate collection, but do not actually process the collected information, there remains a level of manual subjectivity to the acceptance of such submissions which can result in certain projects being unfairly assessed as ineligible, while other projects are unfairly assessed as eligible.

### SUMMARY OF THE INVENTION

It is an object of the present invention to provide a novel computer based system and method for gathering and processing scientific project data that obviates or mitigates at least one of the above-identified disadvantages of the prior art.

An aspect of the invention provides an apparatus for automating credit-eligibility determination of scientific or research projects comprising a storage device for maintaining a set of closed questions representing project parameters and an initial weighting associated with each one of the questions. The storage device also maintains a set of accepted research project data including project parameters and a credit-eligibility report. The apparatus also comprises at least one central processing unit operably connected to the storage device for accessing the questions and the data. At least one central processing unit is operable to receive responses to the questions based on the project parameters and to apply the initial weightings to the questions for the data. At least one central processing unit is also operable to compare the applied weightings with the accepted project data and adjust the weightings until an application of the parameters to the weighted questions substantially matches a finding of the eligibility report. At least one central processing unit is also operable to output a weighted questionnaire including the weighted questions.

The credit eligibility can be for tax credits.

### BRIEF DESCRIPTION OF THE DRAWINGS

The invention will now be described by way of example only, and with reference to the accompanying drawings, in which:

FIG. 1 is a schematic representation of a computer based apparatus for gathering and processing scientific project data in accordance with an embodiment of the invention;

FIG. 2 is a flowchart depicting a method of gathering and processing scientific project data in accordance with another embodiment of the invention;

FIG. 3 shows an exemplary performance of a step in the method of FIG. 2 using the apparatus of FIG. 1;

FIG. 4 shows an exemplary performance of a step in the method of FIG. 2 using the apparatus of FIG. 1;

FIG. 5 shows an exemplary performance of a step in the method of FIG. 2 using the apparatus of FIG. 1;

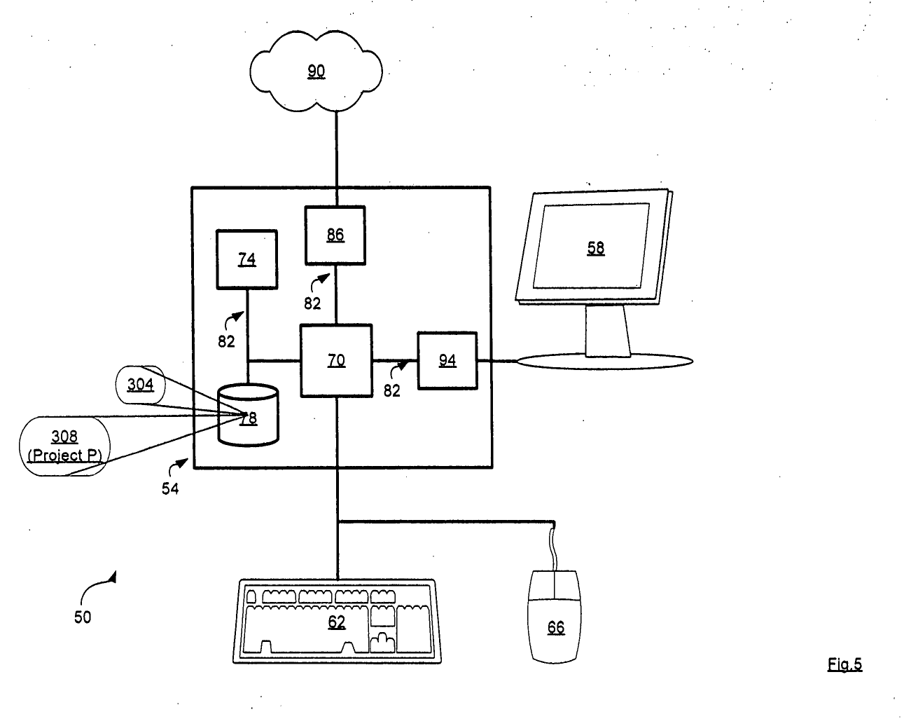

FIG. 6 shows an exemplary performance of a step in the method of FIG. 2 using the apparatus of FIG. 1;

FIG. 7 shows an exemplary performance of a step in the method of FIG. 2 using the apparatus of FIG. 1;

FIG. 8 shows an exemplary performance of a step in the method of FIG. 2 using the apparatus of FIG. 1;

FIG. 9 shows an exemplary performance of a step in the method of FIG. 2 using the apparatus of FIG. 1;

FIG. 10 shows an exemplary performance of a step in the method of FIG. 2 using the apparatus of FIG. 1;

FIG. 11 shows an exemplary performance of a step in the method of FIG. 2 using the apparatus of FIG. 1;

FIG. 12 shows an exemplary performance of a step in the method of FIG. 2 using the apparatus of FIG. 1;

FIG. 13 shows an exemplary performance of a step in the method of FIG. 2 using the apparatus of FIG. 1;

FIG. 14 is a schematic representation of a computer based apparatus for gathering and processing scientific project data in accordance with another embodiment of the invention;

FIG. 15 is a flowchart depicting a method of gathering and processing scientific project data in accordance with another embodiment of the invention;

FIG. 16 shows an exemplary performance of a step in the method of FIG. 2 using the apparatus of FIG. 15;

FIG. 17 shows an exemplary performance of a step in the method of FIG. 2 using the apparatus of FIG. 15; and,

FIG. 18 is a flowchart depicting a method of gathering and processing scientific project data in accordance with another embodiment of the invention.

### DETAILED DESCRIPTION OF THE INVENTION

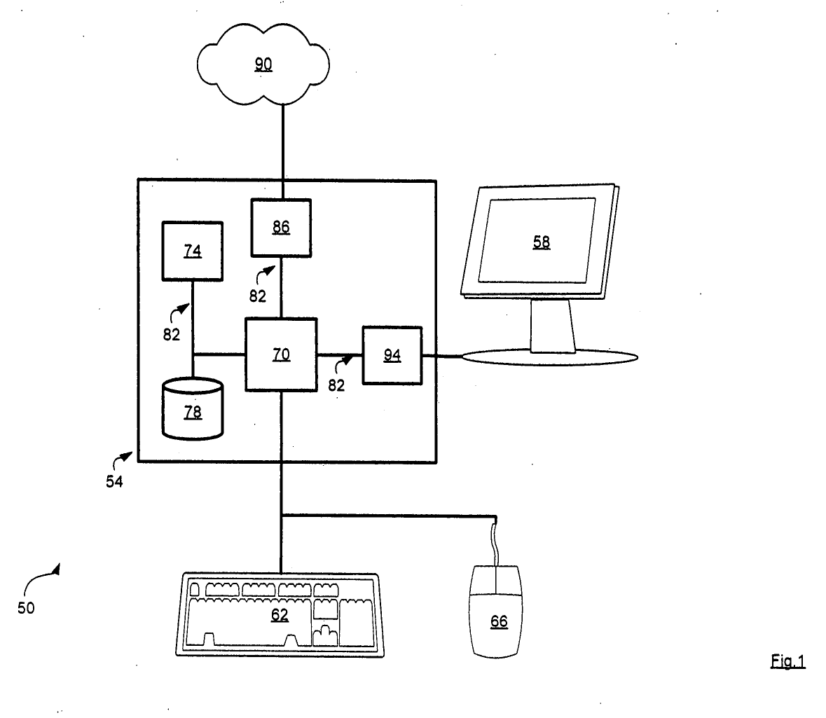

Referring now to FIG. 1, an apparatus for gathering and processing scientific project data is indicated generally at 50. In the present embodiment, apparatus 50 is a general purpose desktop computer, but can be other types of computing devices including a server, client, terminal, personal digital assistant or any other computing device. Apparatus 50 comprises a tower 54, connected to an electronic display 58 for presenting output to a user. Tower 54 is also connected to a keyboard 62 and a mouse 66 for receiving input from a user. Other output devices, in addition to display 58, and input devices, in addition to, or in lieu of, keyboard 62 and mouse 66, will occur to those of skill in the art.

Tower 54 typically houses at least one central processing unit 70 (“CPU”) coupled to random access memory 74 (“RAM”) and one or more persistent storage devices 78, (such as a hard disc drive) via a bus 82. As an example, a suitable central processing unit 70 can be Pentium 4® central processing units from Intel Corporation, Santa Clara Corporate Office, 2200 Mission College Blvd., Santa Clara, Calif. 95052-8119, USA. An exemplary operating system which can be used on tower 54 is Windows XP® from Microsoft Corporation, One Microsoft Way, Redmond, Wash. 98052-6399, USA. The resulting computing environment of apparatus 50, in this example, is often referred to as an Intel-based machine running Windows XP. However, other computing environments, including different central processing units 70 and/or different operating systems and/or other components of apparatus 50 will occur to those of skill in the art and are within the scope of the invention. In a present embodiment, tower 54 also includes a network interface card 86 and connects to a network 90, which can be the Internet, and/or an intranet and/or any other type of network for interconnecting a plurality of computers, as desired. Tower 54 also includes a video card 94 for rendering information outputted from CPU 70 onto display 58.

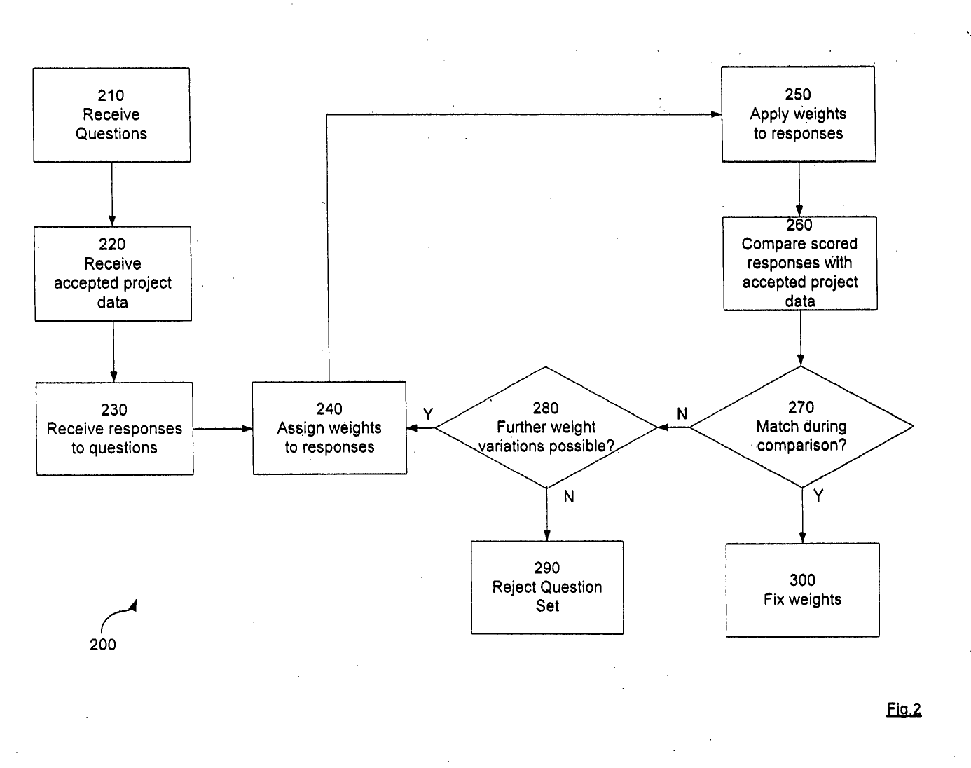

Apparatus 50 is generally operable to determine appropriate weights to be assigned to responses corresponding to a plurality of closed questions, such that when the resulting questionnaire is presented to applicants, the results that are received can be processed scientific project data in a substantially consistent and objective manner. FIG. 2 shows a flowchart representing a method 200 for gathering and processing scientific project data, which is suitable for execution on CPU 70 housed within tower 24. When executing method 200, CPU 70 will make appropriate use of RAM 74 and persistent storage device 78, in order to maintain appropriate persistent and dynamic versions of the hardware instruction set used to implement method 200. Similarly, tower 54 will create appropriate swap files for temporary data on persistent storage device 70 in order to perform method 200. In general tower 54 appropriately utilize of the computing environment of apparaus 50 in order to effect implementation of method 200.

It will thus be assumed that method 200 in FIG. 2 is operated using apparatus 50. However, it is to be understood that apparatus 50 and/or method 200 can be varied, and need not work exactly as discussed herein in conjunction with each other, and that such variations are within the scope of the present invention.

Beginning first at step 210, questions are received. In a present embodiment, the questions at step 210 is a set of closed questions to which responses can be used to assess eligibility under a science and/or research tax credit program such as SR&ED. As used herein, the term closed questions means questions to which no text-based or other open response is possible, but where the only validly accepted responses to such questions are fixed, such as “yes” and “no” and/or “don't know”. Other closed questions include selections from a list of multiple options.

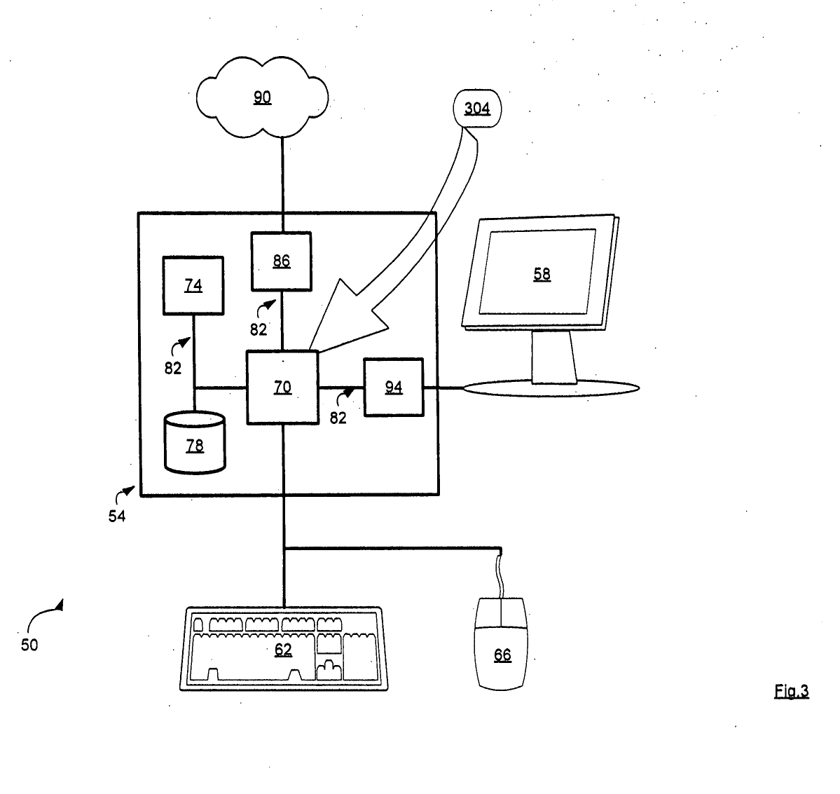

The performance of step 210 is represented in FIG. 3 which shows apparatus 50 and a set of closed questions, represented by an oval indicated at reference 304. Questions 304 are depicted with an arrow towards CPU 70, representing questions 304 being received by CPU 70 in tower 54 and stored in persistent storage 78 of tower 54, and thereby accessible to RAM 74 and CPU 70 during performance of the remainder of method 200. Data 308 can be received indirectly from another computing device via network 90, or entered directly via keyboard 62 as desired.

In order to assist in the explanation of the teachings herein, Table I shows a short list of questions that can form questions 304.

TABLE I
Example list of Questions 304

| Question | | Acceptable |
|---|---|---|
| Number | Question | Responses |
| 1. | Does the project include Canadian Internal | 1. Yes |
| | Based Labour? | 2. No |
| 2. | Does the project include Canadian External | 1. Yes |
| | Based Labour? | 2. No |
| 3. | Does the project include fixed priced | 1. Yes |
| | foreign developed or customized | 2. No |
| | deliverables? | |
| 4. | Does the project include foreign “Time | 1. Yes |
| | and Materials” development or | 2. No |
| | customization work? | |
| 5. | Does the project include some Quebec based | 1. Yes |
| | (external or internal) development work? | 2. No |
| 6. | Is this an off-the-shelf solution | 1. Yes |
| | readily/reasonably obtainable from external | 2. No |
| | or internal sources? | |
| 7. | Is there a core solution being developed | 1. Yes |
| | under this project? (a new product, | 2. No |
| | a new service or process) | |
| 8. | Is there maintenance activity associated | 1. Yes |
| | with the project? (Major upgrades or | 2. No |
| | minor enhancements?) | |
| 9. | Is there infrastructure development | 1. Yes |
| | associated with the project (de facto use | 2. No |
| | of hardware, software licenses greater | |
| | than fifty percent for development | |
| | during fiscal year) | |
| 10. | Is there development in support of | 1. Yes |
| | operations? | 2. No |
| 11. | Are there other cost centres associated | 1. Yes |
| | with the project (e.g. non-technical | 2. No |
| | staff supporting project?) | |
| 12. | Is there a documentation program associated | 1. Yes |
| | with the project | 2. No |

Notwithstanding the information shown in Table I, it is to be understood that typically a much larger number of questions 300 are provided than the list shown in Table I. Generally, the number and nature of questions 304 are chosen to generate responses that match as close as possible the information that is used to ascertain eligibility under SR&ED. In general, however, the number and nature of questions is not particularly limited and can be configured as desired.

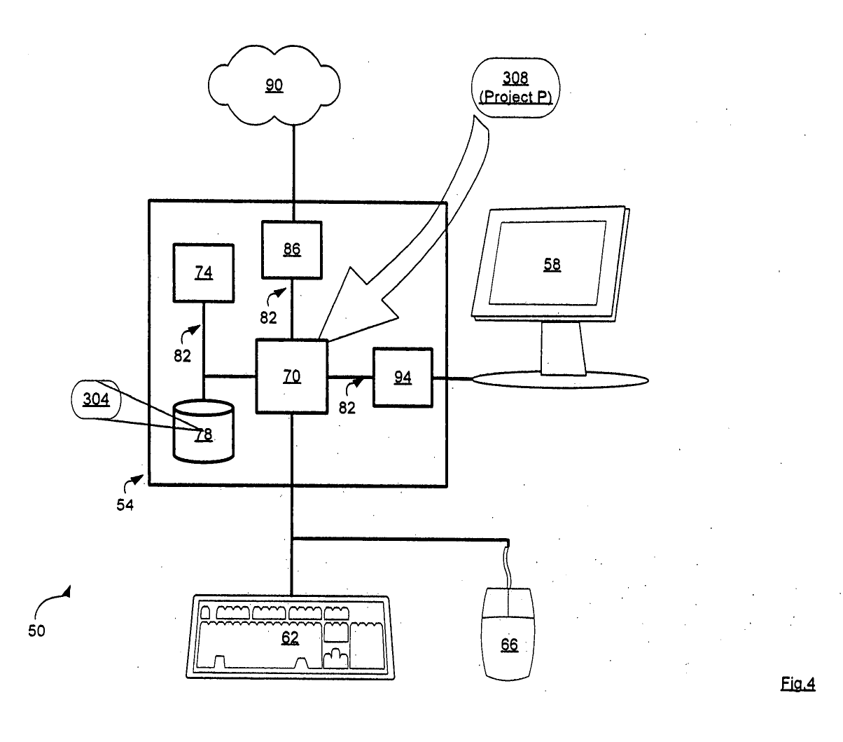

Next, at step 220, accepted program data is received. The performance of step 220 is represented in FIG. 4 which shows apparatus 50 and a set of accepted program data, represented by an oval indicated at reference 308. Data 308 are depicted with an arrow towards CPU 70, representing information relating to a project P being received by CPU 70 in tower 54 and stored in persistent storage 78 of tower 54, to be accessible to RAM 74 and CPU 70 as appropriate, for later usage during performance of method 200. Data 308 can be received indirectly from another computing device via network 90, or entered directly via keyboard 62 as desired.

In a present embodiment, data 308 thus represents a known project P for which tax credits were issued in a previous year for the SR&ED program. Data 308 can thus include the information that was submitted to relevant authorities to assess eligibility for that project. Data 308 can also include reports or results generated by those authorities indicating that project P was determined to be eligible for credits under SR&ED.

Next, at step 230, responses to the questions are received. Such responses correspond to data 308, as those responses would have been generated by posing questions 304 for project P. Put in other words, questions 304 are presented at step 230, and responses to those questions are received for the particulars of project P by analyzing data 308.

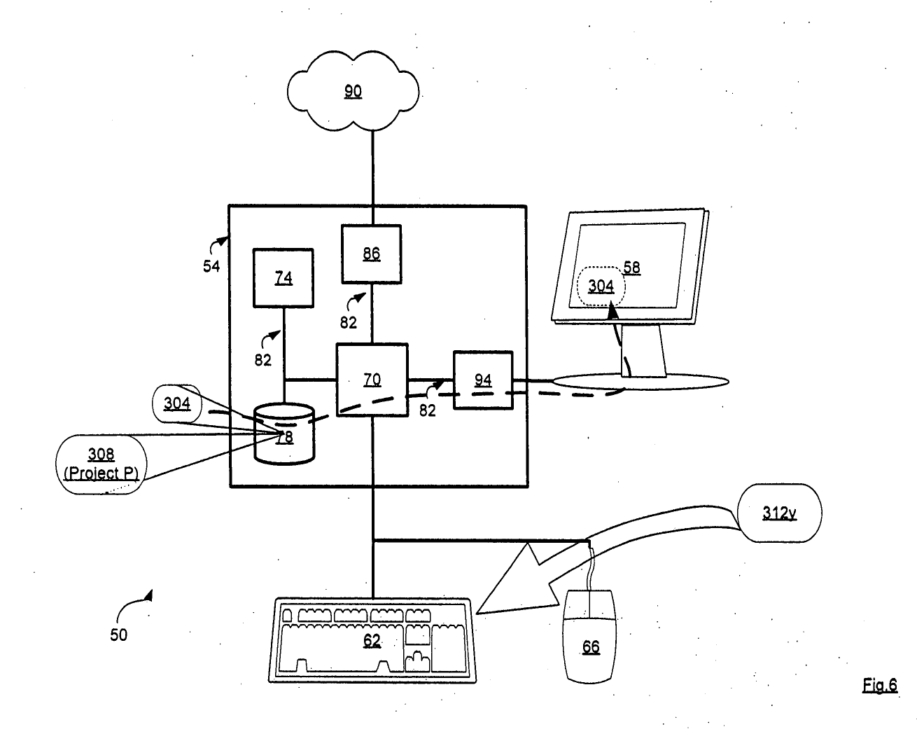

Step 230 can be performed in at least two ways. As a first example, the performance of step 230 can be performed according to the representation in FIG. 6, which shows questions 304 being presented on display 58, and responses 312y to those questions being received at CPU 70 via keystrokes on keyboard 62 and mouse clicks using mouse 66.

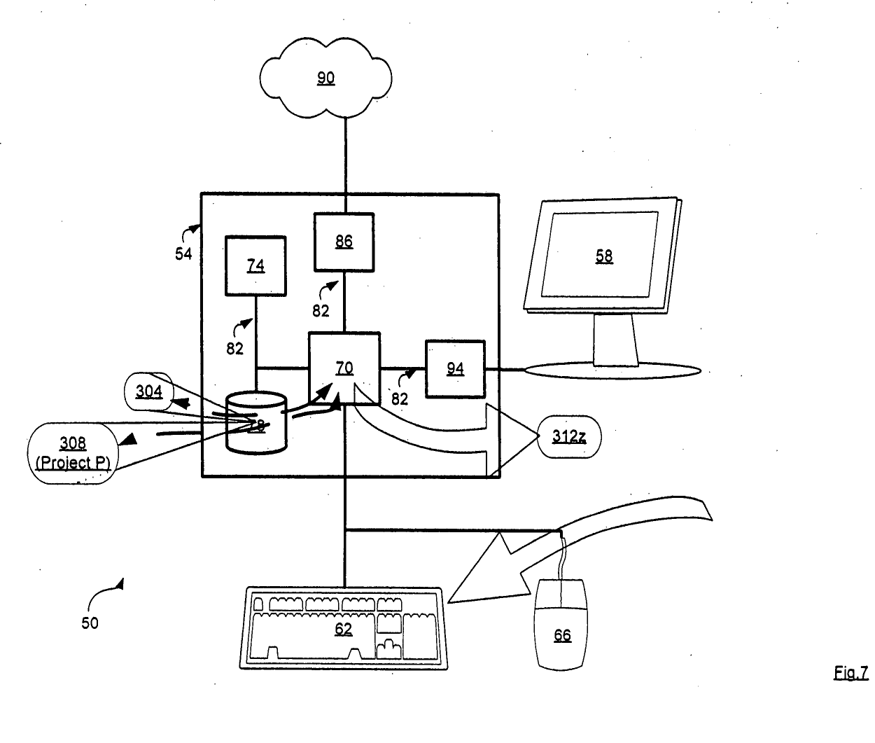

As a second example, the performance of step 230 can be performed according to the representation in FIG. 7, which shows questions 304 and data 308 being queried by CPU 70 so that CPU 70 can automatically generate responses 312z for each of questions 304.

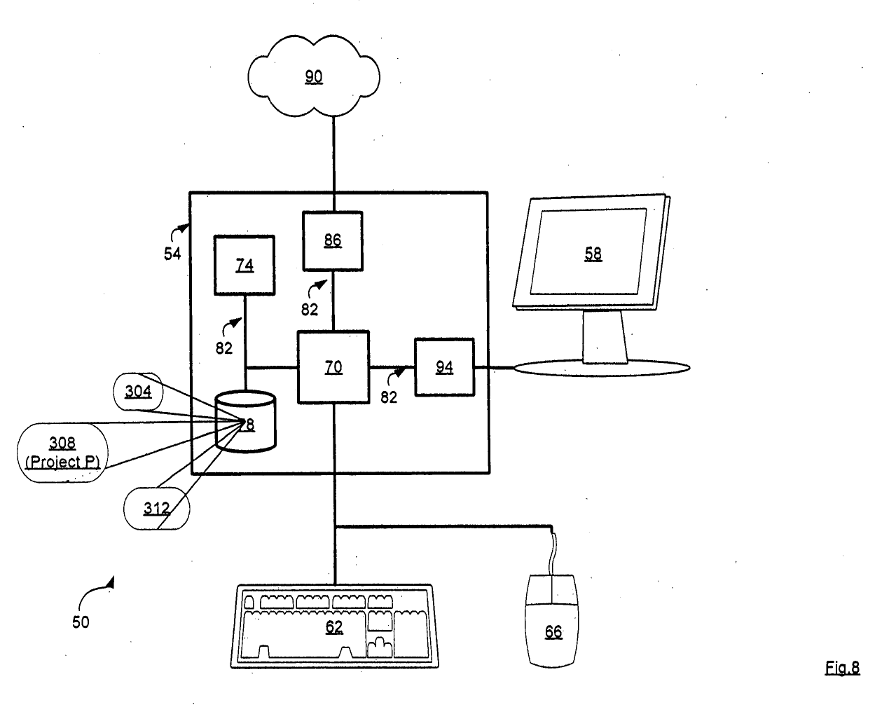

Whichever way is used to perform step 230, the result set of responses 312y or 312z (referred to hereafter as responses 312) is next stored on persistent storage 78, such storage being represented in FIG. 8.

Table II shows an example of responses 312 for questions 304 as posed in related to Project P, as would be stored in persistent storage 78 after performance of step 230.

TABLE II
Example responses 312 for project P to Questions 304

| Question | | Acceptable | |
|---|---|---|---|
| Number | Question | Responses | Response |
| 1. | Does the project include | 1. Yes | Yes |
| | Canadian Internal | 2. No | |
| | Based Labour? | | |
| 2. | Does the project include | 1. Yes | No |
| | Canadian External | 2. No | |
| | Based Labour? | | |
| 3. | Does the project include | 1. Yes | No |
| | fixed priced foreign | 2. No | |
| | developed or customized | | |
| | deliverables? | | |
| 4. | Does the project include | 1. Yes | No |
| | foreign “Time and | 2. No | |
| | Materials” development | | |
| | or customization work? | | |
| 5. | Does the project include | 1. Yes | Yes |
| | some Quebec based | 2. No | |
| | (external or internal) | | |
| | development work? | | |
| 6. | Is there an off-the-shelf | 1. Yes | No |
| | solution readily/reasonably | 2. No | |
| | obtainable from external or | | |
| | internal sources? | | |
| 7. | Is there a core solution | 1. Yes | Yes |
| | being developed under | 2. No | |
| | this project? (a new | | |
| | product, a new service or | | |
| | process) | | |
| 8. | Is there maintenance activity | 1. Yes | Yes |
| | associated with the project? | 2. No | |
| | (Major upgrades or minor | | |
| | enhancements?) | | |
| 9. | Is there infrastructure | 1. Yes | Yes |
| | development associated | 2. No | |
| | with the project (de facto | | |
| | use of hardware, software | | |
| | licenses greater than fifty | | |
| | percent for development | | |
| | during fiscal year) | | |
| 10. | Is there development in | 1. Yes | Yes |
| | support of operations? | 2. No | |
| 11. | Are there other cost centres | 1. Yes | No |
| | associated with the project | 2. No | |
| | (e.g. non-technical staff | | |
| | supporting project?) | | |
| 12. | Is there a documentation | 1. Yes | No |
| | program associated | 2. No | |
| | with the project | | |

Next, at step 240, weights are assigned to each of the responses 312 received at step 230. During the first pass of method 200 when step 240 is reached for the first time, the weights that are assigned are an initial, default set of weights simply used to begin the process of determining appropriate weights. In a present embodiment, it will be assumed that weights are assigned on a scale from zero to five, with zero being the lowest weight, and five being the highest weight. (In other embodiments, the initial default weights could be entered as default weights at step 210.)

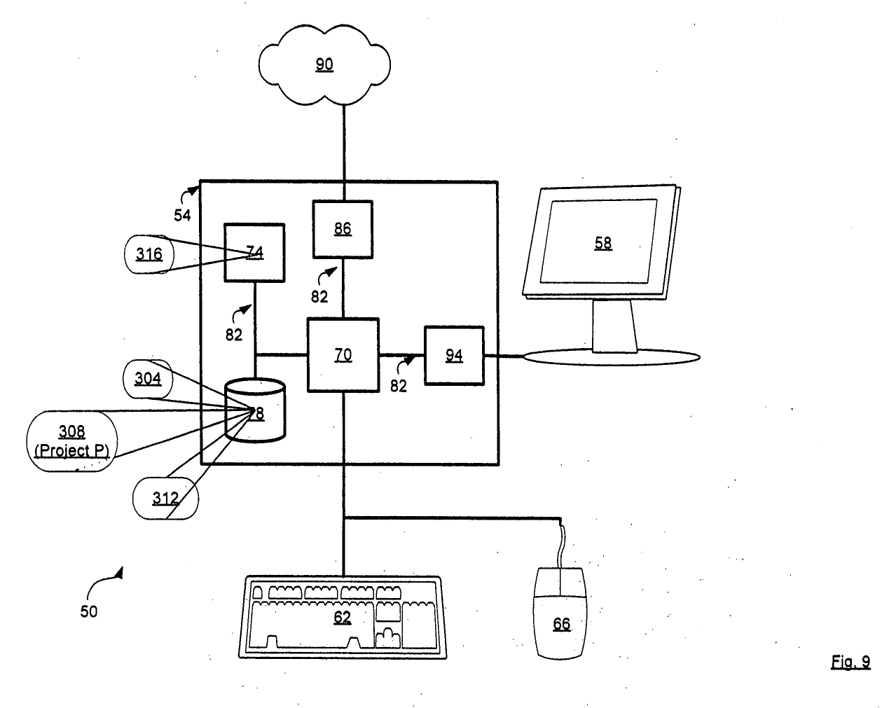

Table III shows an example of set of weights for responses 312 and associated questions 304 as posed in related to Project P. As represented in FIG. 9, the contents of Table III are maintained as a draft questionnaire 316 stored in RAM 74 after performance of step 240. The storage of draft questionnaire 316 in RAM 74

TABLE III
Draft questionnaire 316
Including Initial weights for responses 312 for
project P to Questions 304

| Question | | Acceptable | | Weight |
|---|---|---|---|---|
| Number | Question | Responses | Response | (0-5) |
| 1. | Does the project | 1. Yes | Yes | 3 |
| | include Canadian | 2. No | | |
| | Internal Based | | | |
| | Labour? | | | |
| 2. | Does the project | 1. Yes | No | 3 |
| | include Canadian | 2. No | | |
| | External Based | | | |
| | Labour? | | | |
| 3. | Does the project | 1. Yes | No | 3 |
| | include fixed | 2. No | | |
| | priced foreign | | | |
| | developed or | | | |
| | customized | | | |
| | deliverables? | | | |
| 4. | Does the project | 1. Yes | No | 3 |
| | include foreign | 2. No | | |
| | “Time and | | | |
| | Materials” | | | |
| | development or | | | |
| | customization | | | |
| | work? | | | |
| 5. | Does the project | 1. Yes | Yes | 3 |
| | include some | 2. No | | |
| | Quebec based | | | |
| | (external or | | | |
| | internal) | | | |
| | development work? | | | |
| 6. | Is this an | 1. Yes | No | 3 |
| | off-the-shelf | 2. No | | |
| | solution | | | |
| | readily/reasonably | | | |
| | obtainable | | | |
| | from external or | | | |
| | internal sources? | | | |
| 7. | Is there a core | 1. Yes | Yes | 3 |
| | solution being | 2. No | | |
| | developed under | | | |
| | this project? | | | |
| | (a new product, | | | |
| | a new service | | | |
| | or process) | | | |
| 8. | Is there maintenance | 1. Yes | Yes | 3 |
| | activity associated | 2. No | | |
| | with the project? | | | |
| | (Major upgrades or | | | |
| | minor | | | |
| | enhancements?) | | | |
| 9. | Is there | 1. Yes | Yes | 3 |
| | infrastructure | 2. No | | |
| | development | | | |
| | associated with | | | |
| | the project (de | | | |
| | facto use of | | | |
| | hardware, software | | | |
| | licenses greater | | | |
| | than fifty percent | | | |
| | for development | | | |
| | during fiscal | | | |
| | year) | | | |
| 10. | Is there development | 1. Yes | Yes | 3 |
| | in support of | 2. No | | |
| | operations? | | | |
| 11. | Are there other cost | 1. Yes | No | 3 |
| | centres associated | 2. No | | |
| | with the project | | | |
| | (e.g. non-technical | | | |
| | staff supporting | | | |
| | project?) | | | |
| 12. | Is there a | 1. Yes | No | 3 |
| | documentation | 2. No | | |
| | program associated | | | |
| | with the project | | | |

Next, at step 250, the weights from step 240 are applied to the responses from step 230. In a present embodiment, this step is performed employing CPU 70 to multiply the weight under the weight column for a given cell in Table III with a “one” if there is a “yes” in the corresponding cell under the response column; and by multiplying the weight under the weight column for a given cell in Table III with a “zero” if there is a “no” in the corresponding cell under the response column, to produce a “Score” Column.

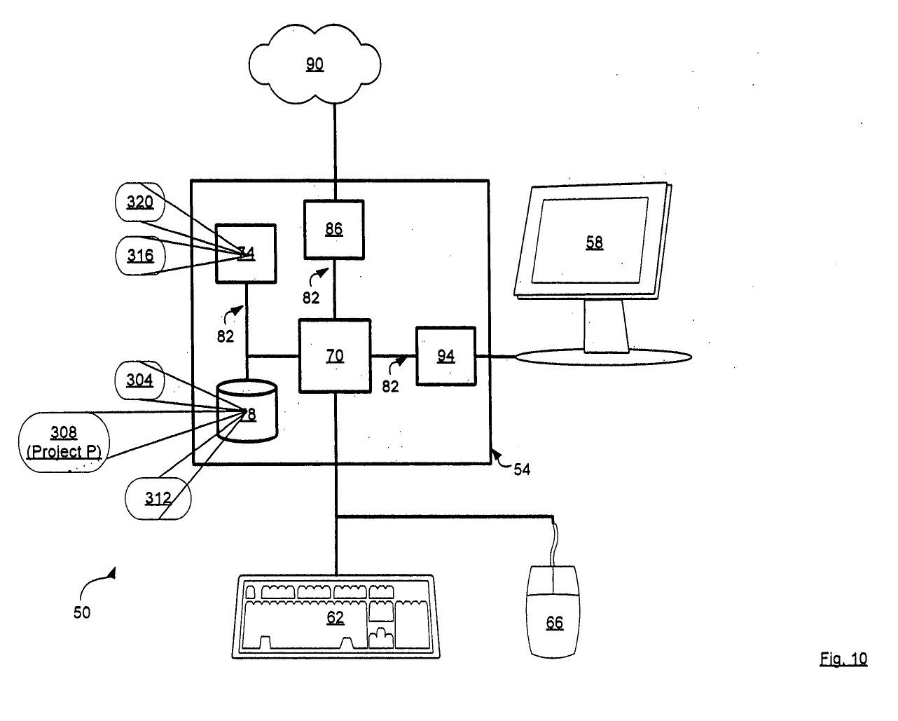

Table IV shows an example of the application of weights to the responses, including a “score” column. As represented in FIG. 10, the contents of Table III are maintained as a scored questionnaire 320 stored in RAM 74 after performance of step 250 by CPU 70.

TABLE IV
Scored questionnaire 320
Including Initial weights for responses 312 for
project P to Questions 304

| Question | | Acceptable | | Weight | |
|---|---|---|---|---|---|
| Number | Question | Responses | Response | (0-5) | Score |
| 1. | Does the project include | 1. Yes | Yes | 3 | 3 |
| | Canadian Internal Based | 2. No | | | |
| | Labour? | | | | |
| 2. | Does the project include | 1. Yes | No | 3 | 0 |
| | Canadian External Based | 2. No | | | |
| | Labour? | | | | |
| 3. | Does the project include fixed | 1. Yes | No | 3 | 0 |
| | priced foreign developed or | 2. No | | | |
| | customized deliverables? | | | | |
| 4. | Does the project include | 1. Yes | No | 3 | 0 |
| | foreign “Time and Materials” | 2. No | | | |
| | development or customization | | | | |
| | work? | | | | |
| 5. | Does the project include some | 1. Yes | Yes | 3 | 3 |
| | Quebec based (external or | 2. No | | | |
| | internal) development work? | | | | |
| 6. | Is there an off-the-shelf | 1. Yes | No | 3 | 0 |
| | solution readily/reasonably | 2. No | | | |
| | obtainable from external or | | | | |
| | internal sources? | | | | |
| 7. | Is there a core solution being | 1. Yes | Yes | 3 | 3 |
| | developed under this project? | 2. No | | | |
| | (a new product, a new service | | | | |
| | or process) | | | | |
| 8. | Is there maintenance activity | 1. Yes | Yes | 3 | 3 |
| | associated with the project? | 2. No | | | |
| | (Major upgrades or minor | | | | |
| | enhancements?) | | | | |
| 9. | Is there infrastructure | 1. Yes | Yes | 3 | 3 |
| | development associated with | 2. No | | | |
| | the project (use of hardware, | | | | |
| | software licenses greater than | | | | |
| | fifty percent for development | | | | |
| | during fiscal year) | | | | |
| 10. | Is there development in | 1. Yes | Yes | 3 | 3 |
| | support of operations? | 2. No | | | |
| 11. | Are there other cost centres | 1. Yes | No | 3 | 0 |
| | associated with the project | 2. No | | | |
| | (e.g. non-technical staff | | | | |
| | supporting project?) | | | | |
| 12. | Is there a documentation | 1. Yes | No | 3 | 0 |
| | program associated with the | 2. No | | | |
| | project | | | | |
| | | | | TOTAL | 18 |
| | | | | SCORE | 30% |

Thus, as a result of performing step 250, a total score of eighteen out of a possible sixty (i.e. a maximum score of “five” a total of “twelve” questions) is achieved using the weights assigned at step 240, for a percentage of eighteen divided by sixty times one hundred for a total score of thirty percent.

Next, at step 260, a comparison is performed between the responses from step 250 with the accepted project data step 220. This step is performed by having CPU 70 access data 308 from persistent storage 78 and comparing it with scored questionnaire 320 stored in RAM 74. The means by which such a comparison is effected is not particularly limited, but in the present example the score of thirty percent from scored questionnaire 320 can be applied against the overall finding from data 308 that project P was considered eligible for SR&ED tax credits, and yet a thirty percent score is too low a threshold against which to determine that other projects are necessarily eligible for SR&ED tax credits.

Accordingly, at step 270, a determination is made as to whether there was a match between the total score from scored questionnaire 320 and the eligibility criteria from data 308. Since the thirty percent score is too low, it would be determined that there was no match, and method 200 would advance to step 280. (However, as will be discussed further below, if at step 270 a determination was made that the weighting resulted in a match, then method 200 would advance to step 300 and, the weighting from step 240 would be fixed thereby finalizing questionnaire 316 for use in conjunction with new projects for which tax credit eligibility is to be assessed.)

Continuing with the present example, at step 280 a determination is made as to whether further weighting variations are possible. Since there has been only one pass through step 240, then at step 280 it would be determined that “yes”, further weight variations are possible and method 200 would return back to step 240. (However, if it at step 280 it was determined that all weight variations had been attempted, then method 200 would advance to step 290 and questions 304 would be rejected as unsuitable for assessing SR&ED eligibility. At this point method 200 could begin anew by entering new set of questions at step 210, thereby continually performing method 200 until a question set is accepted)

Continuing with the present example, once method returns to step 240 from step 280, the weights from draft questionnaire 316 in Table III can be reassigned through adjustment to those weights.

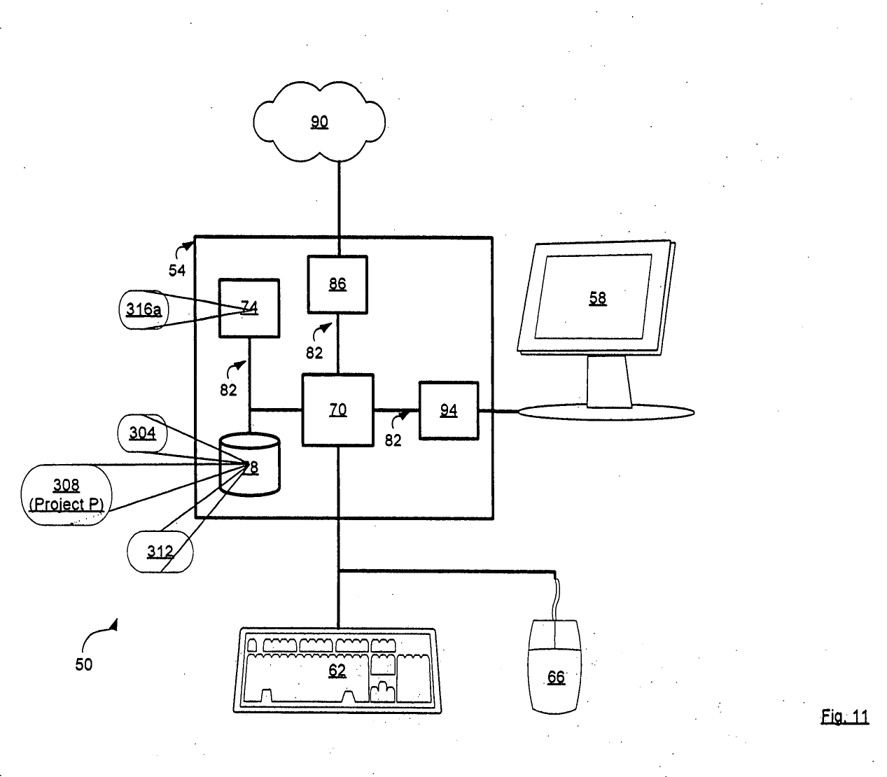

Table V shows an example of new set of weights for responses 312 and associated questions 304 as posed in relation to Project P. As represented in FIG. 11, the contents of Table V are maintained as a draft questionnaire 316a stored in RAM 74 after performance of step 240.

TABLE V
Draft questionnaire 316a
Including adjusted weights for responses 312 for
project P to Questions 304

| Question | | Acceptable | | Weight |
|---|---|---|---|---|
| Number | Question | Responses | Response | (0-5) |
| 1. | Does the project | 1. Yes | Yes | 5 |
| | include Canadian | 2. No | | |
| | Internal Based | | | |
| | Labour? | | | |
| 2. | Does the project | 1. Yes | No | 4 |
| | include Canadian | 2. No | | |
| | External Based | | | |
| | Labour? | | | |
| 3. | Does the project | 1. Yes | No | 4 |
| | include fixed | 2. No | | |
| | priced foreign | | | |
| | developed or | | | |
| | customized | | | |
| | deliverables? | | | |
| 4. | Does the project | 1. Yes | No | 4 |
| | include foreign | 2. No | | |
| | “Time and | | | |
| | Materials” | | | |
| | development or | | | |
| | customization | | | |
| | work? | | | |
| 5. | Does the project | 1. Yes | Yes | 5 |
| | include some | 2. No | | |
| | Quebec based | | | |
| | (external or | | | |
| | internal) | | | |
| | development work? | | | |
| 6. | Is there an | 1. Yes | No | 4 |
| | off-the-shelf | 2. No | | |
| | solution | | | |
| | readily/reasonably | | | |
| | obtainable from | | | |
| | external or | | | |
| | internal sources? | | | |
| 7. | Is there a core | 1. Yes | Yes | 5 |
| | solution being | 2. No | | |
| | developed under | | | |
| | this project? | | | |
| | (a new product, | | | |
| | a new service | | | |
| | or process) | | | |
| 8. | Is there | 1. Yes | Yes | 5 |
| | maintenance activity | 2. No | | |
| | associated with | | | |
| | the project? | | | |
| | (Major upgrades | | | |
| | or minor | | | |
| | enhancements?) | | | |
| 9. | Is there | 1. Yes | Yes | 5 |
| | infrastructure | 2. No | | |
| | development | | | |
| | associated with | | | |
| | the project (de | | | |
| | facto use of | | | |
| | hardware, software | | | |
| | licenses greater | | | |
| | than fifty percent | | | |
| | for development | | | |
| | during fiscal | | | |
| | year) | | | |
| 10. | Is there development | 1. Yes | Yes | 5 |
| | in support of | 2. No | | |
| | operations? | | | |
| 11. | Are there other | 1. Yes | No | 4 |
| | cost centres | 2. No | | |
| | associated with | | | |
| | the project | | | |
| | (e.g. non-technical | | | |
| | staff supporting | | | |
| | project?) | | | |
| 12. | Is there a | 1. Yes | No | 4 |
| | documentation | 2. No | | |
| | program associated | | | |
| | with the project | | | |

The criteria used to adjust the weights are not particularly limited. In the present example, the criteria simply involved increasing the “yes” answers to a weight of five, and increasing the “no” answers to a weight of four. It is to be reiterated that this is merely an exemplary criteria for the purposes of explaining the present embodiment, and other, more complex criteria can be applied as desired.

Next, method 200 cycles again to step 250, where the weights from step 240 are applied to the responses from step 230. Again, this step is performed employing CPU 70 to multiply the weight under the weight column for a given cell in Table V with a “one” if there is a “yes” in the corresponding cell under the response column; and by multiplying the weight under the weight column for a given cell in Table III with a “zero” if there is a “no” in the corresponding cell under the response column, to produce a “Score” Column.

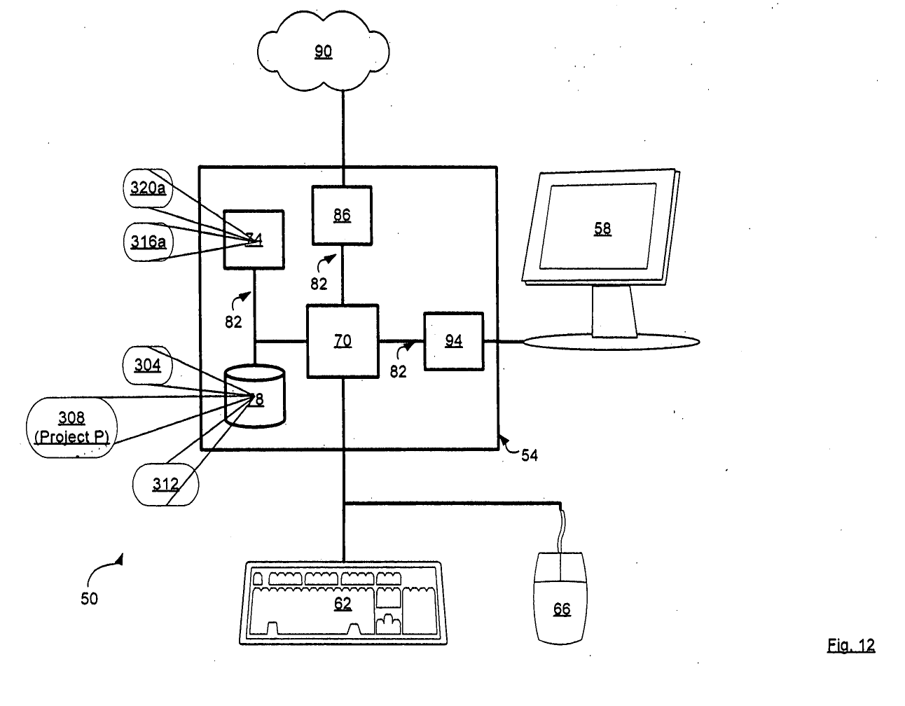

Table V shows an example of the application of weights to the responses, including a “score” column. As represented in FIG. 12, the contents of Table V are maintained as a scored questionnaire 320a stored in RAM 74 after performance of step 250 by CPU 70.

TABLE V
Scored questionnaire 320a
Including adjusted weights for responses 312 for
project P to Questions 304

| Question | | Acceptable | | Weight | |
|---|---|---|---|---|---|
| Number | Question | Responses | Response | (0-5) | Score |
| 1. | Does the project include | 1. Yes | Yes | 5 | 5 |
| | Canadian Internal Based | 2. No | | | |
| | Labour? | | | | |
| 2. | Does the project include | 1. Yes | No | 4 | 0 |
| | Canadian External Based | 2. No | | | |
| | Labour? | | | | |
| 3. | Does the project include fixed | 1. Yes | No | 4 | 0 |
| | priced foreign developed or | 2. No | | | |
| | customized deliverables? | | | | |
| 4. | Does the project include | 1. Yes | No | 4 | 0 |
| | foreign “Time and Materials” | 2. No | | | |
| | development or customization | | | | |
| | work? | | | | |
| 5. | Does the project include some | 1. Yes | Yes | 5 | 5 |
| | Quebec based (external or | 2. No | | | |
| | internal) development work? | | | | |
| 6. | Is there an off-the-shelf | 1. Yes | No | 4 | 0 |
| | solution readily/reasonably | 2. No | | | |
| | obtainable from external or | | | | |
| | internal sources? | | | | |
| 7. | Is there a core solution being | 1. Yes | Yes | 5 | 5 |
| | developed under this project? | 2. No | | | |
| | (a new product, a new service | | | | |
| | or process) | | | | |
| 8. | Is there maintenance activity | 1. Yes | Yes | 5 | 5 |
| | associated with the project? | 2. No | | | |
| | (Major upgrades or minor | | | | |
| | enhancements?) | | | | |
| 9. | Is there infrastructure | 1. Yes | Yes | 5 | 5 |
| | development associated with | 2. No | | | |
| | the project (use of hardware, | | | | |
| | software licenses greater than | | | | |
| | fifty percent for development | | | | |
| | during fiscal year) | | | | |
| 10. | Is there development in | 1. Yes | Yes | 5 | 5 |
| | support of operations? | 2. No | | | |
| 11. | Are there other cost centres | 1. Yes | No | 4 | 0 |
| | associated with the project | 2. No | | | |
| | (e.g. non-technical staff | | | | |
| | supporting project?) | | | | |
| 12. | Is there a documentation | 1. Yes | No | 4 | 0 |
| | program associated with the | 2. No | | | |
| | project | | | | |
| | | | | TOTAL | 30 |
| | | | | SCORE | 50% |

Thus, as a result of performing step 250, a total score of thirty out of a possible sixty (i.e. a maximum score of “five” a total of “twelve” questions) is achieved using the weights assigned at step 240, for a percentage of thirty divided by sixty times one hundred for a total score of fifty percent.

Next, at step 260, a comparison is performed between the responses from step 250 with the accepted project data step 220. This step is performed by having CPU 70 access data 308 from persistent storage 78 and comparing it with scored questionnaire 320a stored in RAM 74. In the present example the score of fifty percent from scored questionnaire 320a can be applied against the overall finding from data 308 that project P was considered eligible for SR&ED tax credits. In this case, it can be determined that a fifty percent score is sufficient threshold against which to determine that other projects are eligible for SR&ED tax credits. (Note to Draft: please clarify)

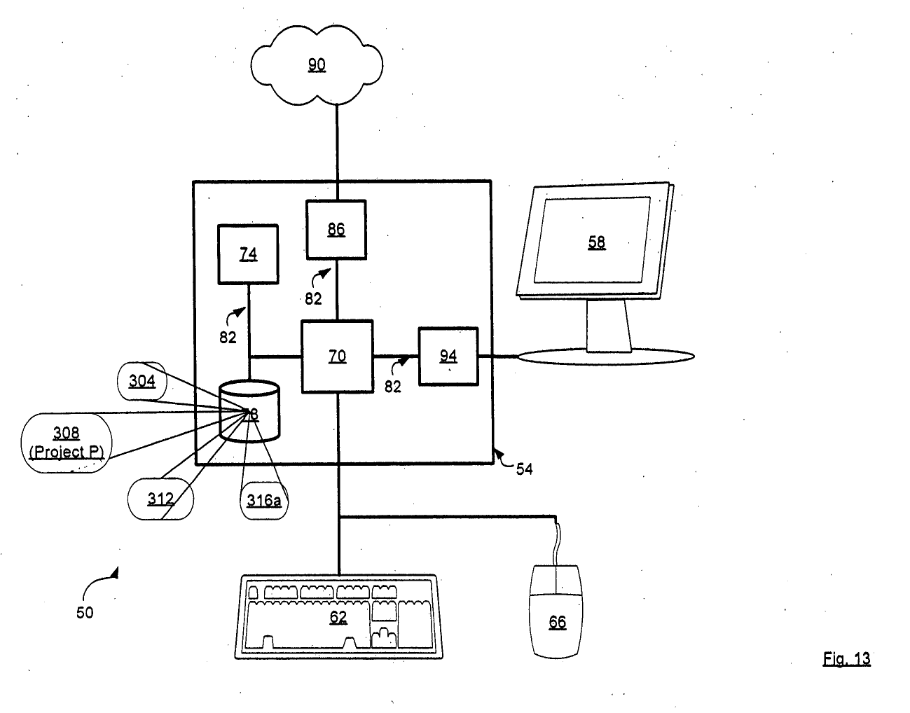

Accordingly, at step 270, a determination is made as to whether there was a match between the total score from scored questionnaire 320 and the eligibility criteria from data 308. Since the fifty percent score is acceptable, it would be determined that there was a match, and method 200 would advance to step 300. The weighting from step 240 is thus fixed thereby finalizing questionnaire 316a for use in conjunction with new projects for which tax credit eligibility is to be assessed. Questionnaire 316a would then be stored in persistent storage 78, as represented in FIG. 13, for subsequent use on apparatus 50, or delivered over network 90 to other entities.

While a specific example was used to explain method 200 in order to specifically generate questionnaire 316a, it should now be apparent that method 200 can cycle any number of times, applying desired adjustments to weightings in order to finally generate a weighted questionnaire, or to ultimately reject the question set received at step 210.

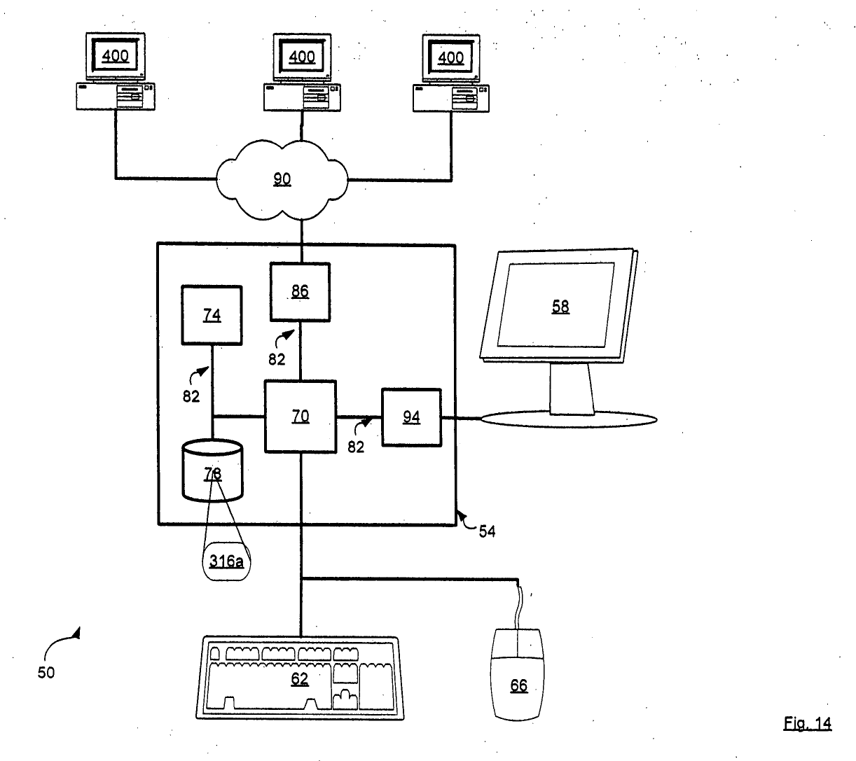

Another embodiment of the invention is shown in FIG. 14, which includes apparatus 50 as previously described as well as a plurality of client devices 400 which are attached to network 90. Client devices 400 are each general purpose computers such as a Pentium-based computer, (or other computing devices such as personal digital assistants, thin clients, etc. with substantially similar functionality) that allow a user to provide input to and receive output from apparatus 50 via network 90. In the present embodiment, each client device 400 is accessible by various users who have information of a particular project for which SR&ED tax credit eligibility is to be assessed, and where such information can be used to complete questionnaire 316a (or any other questionnaire that is generated by method 200 or the like).

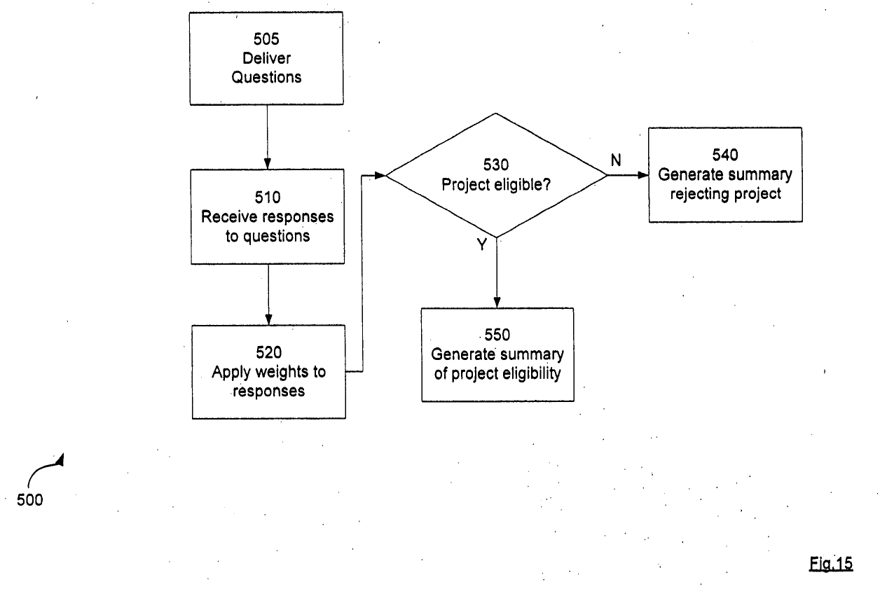

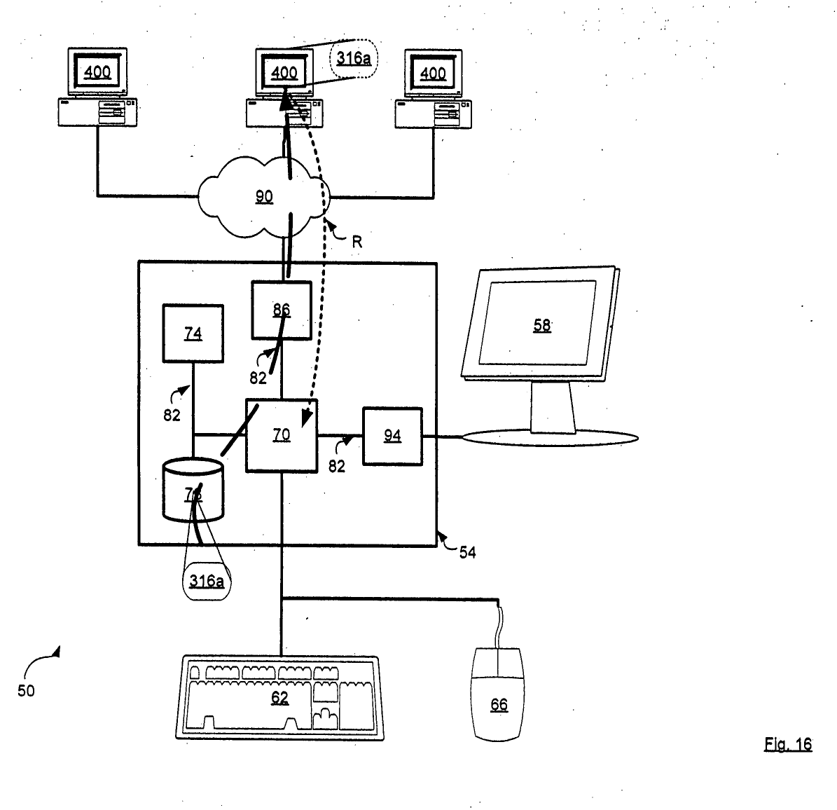

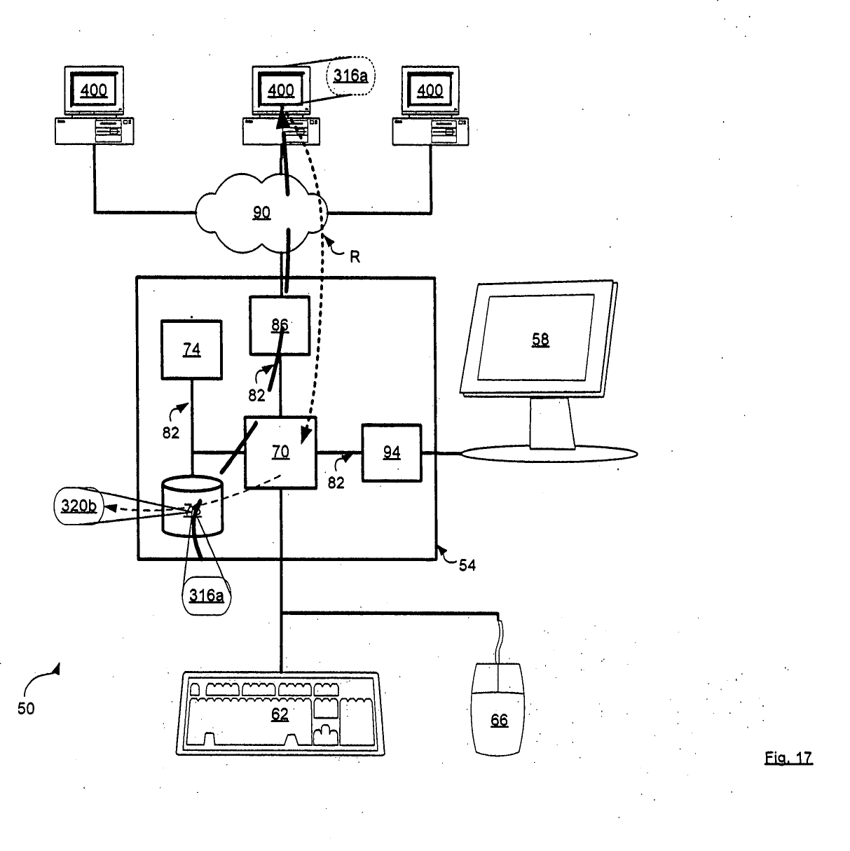

Referring now to FIG. 15, method 500 can be used in conjunction with the embodiment of FIG. 14 in order to administer questionnaire 316a. At step 505, questions are delivered. Using the example of questionnaire 316a, a user at device 400 will log in to device 400 in the usual manner and access apparatus 50 in order to call up questionnaire 316a on device 400, as represented by the presentation of questionnaire 316a on client device 400 in FIG. 16. At step 510, responses to the questions delivered at step 505 are received. To perform this step, the user at device 400 will then complete the questionnaire 316a (substantially in the way as was previously described in relation to method 200 and FIG. 6) such that the responses from the user are received at CPU 70, as represented by the dotted line indicated at reference “R” on FIG. 16. Next, at step 520, CPU 70 will apply the weights associated with that questionnaire 316a to arrive at a scored questionnaire 320b, which will be stored on storage device 78, as shown in FIG. 17. Next, at step 530, a determination is made as to whether the project associated with the responses received at step 510 is eligible, based on the applied weights and total scoring in scored questionnaire 320b. If the scoring is below a predefined threshold, then a determination is made at step 530 that the project is not eligible and method 500 advances to step 540 and a project summary is generated which summarizes the rejection of project. If, however, the scoring is above a predefined threshold (which in the previous example was fifty percent, but can be any desired level), then a determination is made at step 530 that the project is eligible and method 500 advances to step 550 and a project summary is generated which can be used for submission to appropriate authorities.

In a variation of method 200 in FIG. 2, the accepted project data received at step 220 can correspond to one of a plurality of project types that can be eligible for tax credits. For example, in SR&ED, accepted projects types include: a) “P” type projects, which involve some sort of advance or have an element of uncertainty; b) “S” type projects, which involve some sort of support activities, which under Canadian tax law, could be stated as “which involve category D support work” c) “O1” type projects which involve an allotment of overhead costs of all tax-credit eligible projects; d) “O2” type projects, which involve an allotment of overhead costs to an entire group within an organization whose function is to perform R&D.

Thus, a modified version of method 200 can be generated for each project type, so that the particular accepted project data at step 220 includes an identification of the particular project type that has been accepted. As a result, the questions at step 230, and/or the weights fixed at step 300 vary according to the project type. However, in a presently preferred embodiment, the set of questions at step 230 are the same for each type of project, so that only the weightings ultimately assigned to each question at step 240 vary according to the project type identified at step 220. In this manner, a single questionnaire can be employed for all project types, thereby reducing overall complexity of apparatus 50.

Table VI shows a sample question and different weights associated with a predefined response to that question, such weights varying according to project type. Table VI reflects exemplary results when the above-mentioned modified version of method 200 is utilized to generate one set of questions associated with different weights according to different project types.

TABLE VI
Example questionnaire format and sample question
(Generated at step 300 of modified version of method 200)

| | | | | Weight | Weight | Weight | Weight |
|---|---|---|---|---|---|---|---|
| | | | | (P type | (S type | (O1 type | (O2 type |
| Question | | Acceptable | | Project) | Project) | Project)) | Project)) |
| Number | Question | Responses | Response | (0-5) | (0-5) | (0-5) | (0-5) |
| 1 | Does the project | 1. Yes | Yes | 5 | 4 | 3 | 2 |
| | include Canadian | 2. No | | | | | |
| | Internal Based | | | | | | |
| | Labour? | | | | | | |

It is to be emphasized that Table VI only includes one sample question and the associated weights are also merely examples.

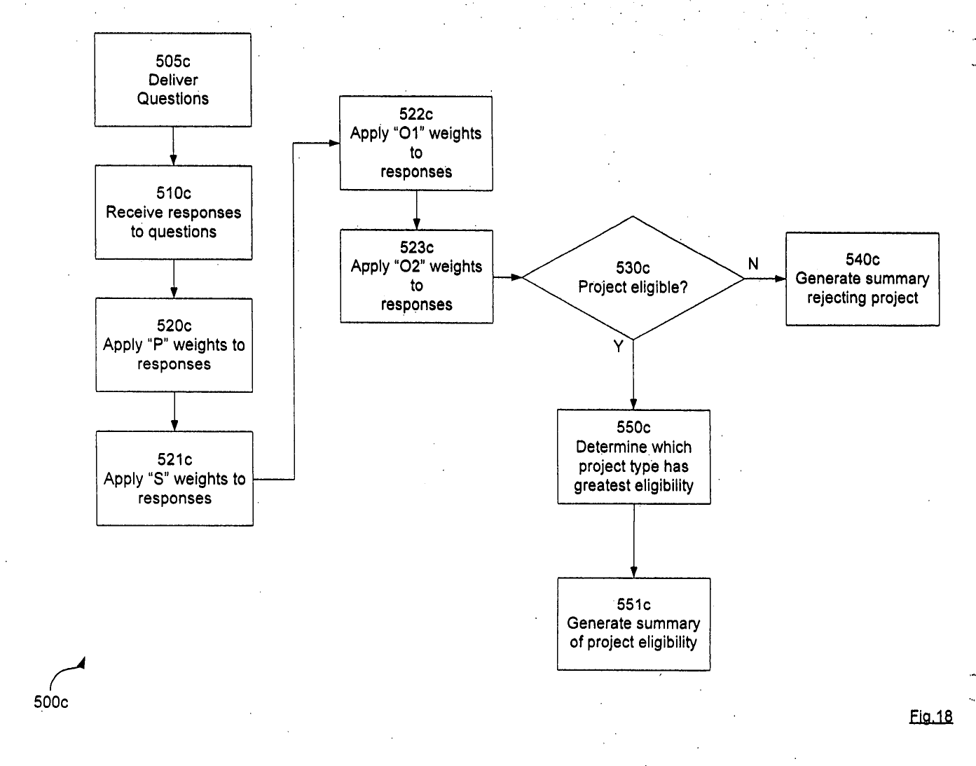

Referring now to FIG. 18, method 500c can be used in conjunction with the embodiment of FIG. 14 in order to administer a complete questionnaire of the format shown in Table VI. Steps 505c and 510c are performed in substantially the same manner as described in relation to method 500, except using a questionnaire formatted based on Table VI.

Next, at step 520c, CPU 70 applies the weights to the questions associated with “P” type projects, as such weightings are defined in Table VI. Likewise, at step 521c, CPU 70 applies the weights to the questions associated with “S” type projects, as such weightings are defined in Table VI. At step 522c, CPU 70 applies the weights to the questions associated with “O1” type projects, as such weightings are defined in Table VI. At step 523c, CPU 70 applies the weights to the questions associated with “O2” type projects, as such weightings are defined in Table VI.

Next, at step 530c, a determination is made as to whether the project associated with the responses received at step 510 is eligible, according to one or more of the project types, based on the applied weights and total scoring as determined at steps 520c, 521c, 522c and 523c. If the scoring is below a predefined threshold, then a determination is made at step 530c that the project is not eligible and method 500c advances to step 540c and a project summary is generated which summarizes the rejection of project. If, however, the scoring is above a predefined threshold for any of the project types, then a determination is made at step 530c that the project is eligible and method 500c advances to step 550c and a determination is made as to which project type has the greatest eligibility. Typically, this determination is made by assessing which project type had the greatest total score when weights were applied to responses. Next, at step 551c, a project summary is generated which can be used for submission to appropriate authorities.

While only specific combinations of the various features and components of the present invention have been discussed herein, it will be apparent to those of skill in the art that desired subsets of the disclosed features and components and/or alternative combinations of these features and components can be utilized, as desired. For example, while a specific apparatus is shown that can be used for the performance of method 200, and a specific apparatus is shown that can be used for the performance of method 500, it should be understood that other computer based apparatus are within the scope of the invention. For example, the apparatuses in FIGS. 1 and 14 can be implemented in a distributed manner, using multiple CPUs, and/or multiple computing devices and/or across one or more clients and/or one or more servers to perform the steps. As another example, while specific reference is made to the use of RAM 74 and storage device 78, it should be understood that other ways of effecting temporary and/or long term storage are also within the scope of the invention. In general, various other computing environments and utilizations of the same that will now occur to those of skill in the art and are envisioned and within the scope of the invention.

The above-described embodiments of the invention are intended to be examples of the present invention and alterations and modifications may be effected thereto, by those of skill in the art, without departing from the scope of the invention which is defined solely by the claims appended hereto.

1. An apparatus for automating tax credit-eligibility determination of scientific or research projects comprising:
a storage device for maintaining a set of closed questions representing project parameters and an initial weighting associated with each one of said questions; said storage device for further maintaining a set of accepted research project data including project parameters and a tax credit-eligibility report; said apparatus further comprising at least one central processing unit operably connected to said storage device for accessing said questions and said data; said at least one central processing unit operable to receive responses to said questions based on said project parameters and to apply said initial weightings to said questions for said data; said at least one central processing unit further operable to compare said applied weightings with said accepted project data and adjust said weightings until an application of said parameters to said weighted questions substantially matches a finding of said eligibility report; said at least one central processing unit further operable to output a weighted questionnaire including said weighted questions.

2. The apparatus of claim 1 wherein the storage device is comprised of at least one of random access memory and a persistent storage device.

3. The apparatus of claim 1 wherein said at least one central processing unit includes a plurality of central processing units each housed in a separate computing device, each of said central processing units in communication with the other.

4. The apparatus of claim 1 wherein said set of accepted research project data includes a project type.

5. The apparatus of claim 4 wherein said project type is based on SR&ED project types selected from the group consisting of “P” type projects; “S” type projects; “O1” type projects; and “O2” type projects.

6. The apparatus of claim 1 wherein said application of said parameters to said weighted questions includes a total sum of all said weighted questions.

7. The apparatus of claim 7 wherein said total sum represents said match between said application and said finding of said eligibility report.

8. A method of automating tax credit-eligibility determination of scientific or research projects comprising:
receiving data representing a set of closed questions used for assessing research data;
receiving a set of accepted research project data including project parameters and an eligibility report of said project data;
receiving a set of responses to each of said questions, said responses corresponding to said project parameters;
applying a weight to said responses to generate a scored questionnaire;
comparing said scored questionnaire with said eligibility report;
adjusting said weights and repeating said applying and comparing steps if said scored questionnaire does not substantially match said eligibility report;
generating a final questionnaire if said scored questionnaire substantially matches said eligibility report;
storing said final questionnaire comprised of said questions and said weightings for subsequent use in assessing eligibility of an additional research project.

9. The method of claim 8 wherein said set of accepted research project data includes a project type.

10. The method of claim 9 wherein said project type is based on one SR&ED project type selected from the group consisting of “P” type projects; “S” type projects; “O1” type projects; and “O2” type projects.

11. The method of claim 8 wherein said application of said parameters to said weighted questions includes a total sum of all said weighted questions.

12. The method of claim 11 wherein said total sum represents said match between said application and said finding of said eligibility report.

13. A method of automating tax credit-eligibility determination of scientific or research projects comprising:
delivering a set of closed weighted questions used for assessing research data;
receiving responses to each of said questions for a research project;
applying weights associated with said weighted questions to said responses to generate a scored questionnaire;
generating a report summarizing project-eligibility if said scored questionnaire meets a predetermined threshold; and,
generating a report summarizing project ineligibility if said scored questionnaire does meet said predetermined threshold.

14. The method of claim 13 wherein said research project includes a project type that is based on SR&ED project types selected from the group consisting of “P” type projects; “S” type projects; “O1” type projects; and “O2” type projects.

15. The method of claim 13 wherein said step of applying said weights includes determining total sum of all responses to said weighted questions.

16. The method of claim 15 wherein said threshold is a number, said threshold being met if said total sum equals or exceeds said number.
